(19) United States
(12) Patent Application Publication
(10) Pub. No.: US 2006/0141115 A1
(43) Pub. Date: Jun. 29, 2006

(54) Method for cooking food by burning denatured ethanol, and applicance for implementing said method

(76) Inventors: Eric Uhrig, Ottange (FR); Laurent Probst, Tomblaine (FR)

Correspondence Address: Gary M Cohen;Strafford Building Number Three, 125 Strafford Avenue, Suite 300, Wayne, PA, 19087-3318, US

(21) Appl. No.: 10/559,255

(22) PCT Filed: Jun. 9, 2004
(86) PCT No.: PCT/FR04/01437

§ 371 Date: Dec. 2, 2005

(30) Foreign Application Priority Data
Jun. 13, 2003 (FR) 03/07183

(51) Int. Cl. A23C 3/00

(52) U.S. Cl. 426/523

(57) ABSTRACT

The invention relates to a method for cooking food positioned in a receptacle, characterized in that:
a predetermined volume V of denatured ethanol with a proof strength of at least 80^{•} is poured on to the food, the ethanol is ignited and left to burn completely.

The invention also relates to apparatuses for implementing the method, such as, for example an apparatus formed of at least a half-tube (3) closed off at each end by half-plates (4) in the shape of half-discs, each comprising a central cut-out (5) for guiding a skewer (2) or half-skewers (8) holding the food that is to be cooked.

The present invention relates to another method for cooking food and for an apparatus for implementing the method.

The prior art already knows numerous ways of cooking food such as, for example, cooking it in a container which receives the heat and then transmits it to the food (a frying pan, a saucepan, etc.) and cooking it in an enclosure or an oven, or cooking it by radiation (grilling) or by hot-air conduction.

These methods of cooking entail large amounts of energy and take a relatively long time because the heat energy progresses from the outside of the food towards the core thereof at a relatively slow pace.

Furthermore, high-frequency radiation cooking (microwaving) heats the core of the food directly without involving the receptacle but does not provide a surface grill effect.

The barbecuing method allows a surface grill effect to be obtained but is not suitable for all types of food. Besides, cooking meat at high temperature encourages the appearance of toxic products, such as polycyclic aromatic hydrocarbons (PAHs), benzopyrenes and heterocyclic amines (HCAs) which are produced respectively in the crispy part of the grilled meat or in the smoke given off, which contaminates the meat.

Furthermore, it is known practice to impart flavours to the food either by direct contact with various spices or flavourings or by maceration, prior to cooking, in an alcohol-containing and scented marinade, or alternatively by basting with a sauce during cooking.

It is therefore known that alcohol is able to impart flavour in the hot or cold state.

Alcohol can also be “flambé”, that is to say ignited in the food but primarily for aesthetic reasons, this operation not causing the food to become cooked. In all cases, the alcohol currently employed in cooking is a wine, or an alcoholic liquid of the eau de vie, vodka, cognac, etc. type with a proof strength of under 50^{•} or 60^{•} maximum, or any alcohol that does not attract the current reduced rates in duty.

The invention consists in using the ethanol to cook the food by direct contact between the food and the flame without producing toxic derivatives and consists in a method for cooking food positioned in a receptacle, characterized in that:
a predetermined volume V of denatured ethanol with a proof strength of at least 80^{•} is poured on to the food,
the ethanol is ignited and left to burn completely.

The invention also relates to an apparatus designed for implementing the method formed of at least a half-tube closed off at each end by half-plates in the shape of half-discs, each comprising a central cut-out for guiding a skewer or half-skewers holding the food that is to be cooked.

According to various optional embodiments, the apparatus may comprise an automatic means for turning the skewer or half-skewers and/or means intended to collect the fat and/or means for continuously supplying the cooking ethanol.

The invention will be better understood with the aid of the description given hereinafter with reference to the following attached figures:

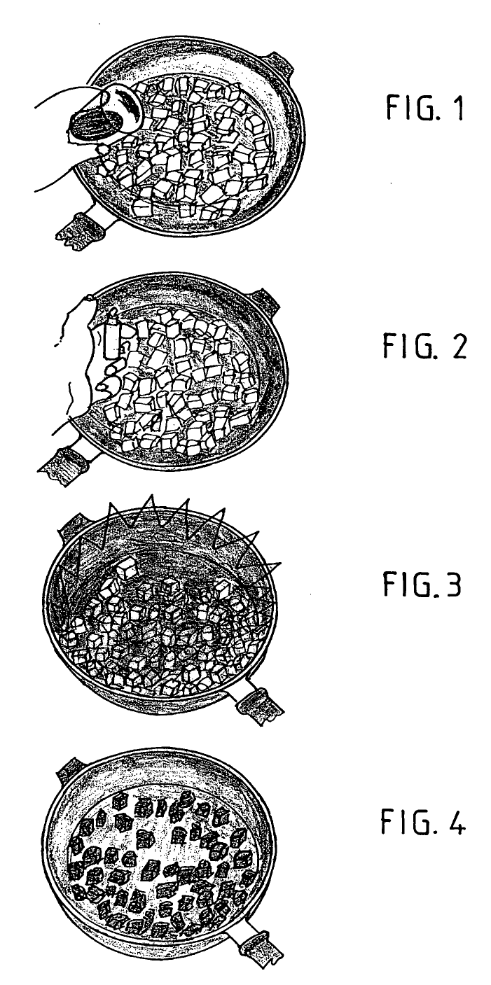

FIG. 1 showing pieces of food placed by way of nonlimiting example in a frying pan into which a volume V of ethanol is poured,

FIGS. 2 and 3 showing the igniting of the ethanol and its burning,

FIG. 4 showing the cooked food after the end of burning,

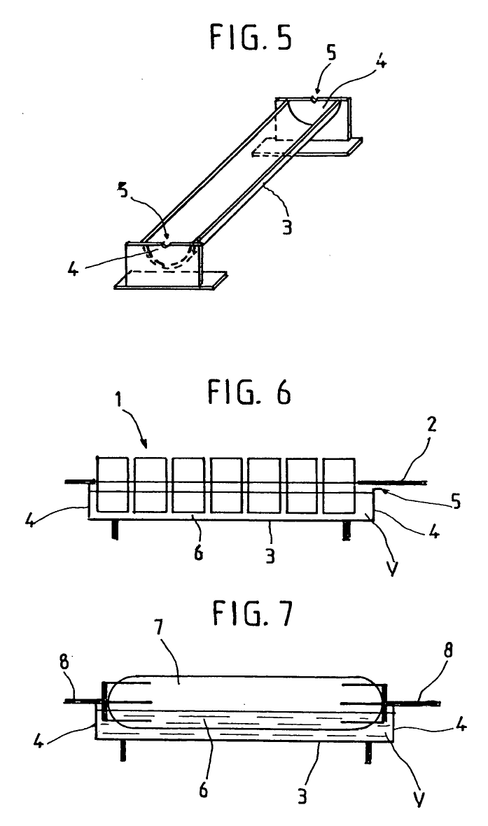

FIG. 5 showing one nonlimiting embodiment of an apparatus for implementing the cooking method according to the invention,

FIG. 6 showing, in longitudinal and vertical section, the apparatus of FIG. 5 in which a kebab is positioned,

FIG. 7 showing, in longitudinal and vertical section, the apparatus of FIG. 5, in which a sausage is positioned.

The basic variant of the novel cooking method according to the invention is to cut the food into pieces that are placed in a receptacle, to pour a predetermined volume V of denatured ethanol with a proof strength of more than 80^{•} on to the food (FIG. 1), then to ignite the ethanol (FIGS. 2 and 3).

When the ethanol has been completely burnt away, burning stops and the pieces of food are instantaneously and completely done (FIG. 4).

By way of indication, to cook 400 g of meat or sausages or crustaceans, a volume V of 10 cl of ethanol with a proof strength of 95^{•} may be provided.

The burning of the ethanol lasts for a few minutes and produces a blue-to-yellow flame measuring 20 to 30 cm, or even 50 cm if the receptacle is shaken.

Cooking takes place by direct contact between the food and the fuel and with the flame and this is something that is entirely novel by comparison with traditional cooking methods and does not produce toxic substances as barbecuing does.

This is because the burning of ethanol produces only water and carbon dioxide CO₂.

According to a variant of the cooking method, use may be made of scented or flavoured ethanol obtained in various ways:
by adding pepper or spices or flavourings to the cooking ethanol,
by infusing aromatic herbs (for example thyme, rosemary, etc.) or by macerating fresh plants (for example: sweet peppers, garlic, etc.) in the ethanol and prior to cooking so that the ethanol picks up the flavours. Infusion or maceration may be quick, of the order of 24 to 48 h, and once flavoured, the ethanol can be used, filtered or otherwise, to cook the food using the method just described,
by flavouring with aromatic extracts of an industrial type (essences, concentrated oils, for example).

The cooking method according to the invention is particularly suited to meat, kebabs, sausages, fish or crustaceans which may or may not be cut up into pieces according to their size, and to kebabs. For example, and nonlimitingly, the pieces have a volume contained inside cubes with a side length measuring 1.5 to 2.5 cm. Of course, food that is not very bulky (intended for deep frying, prawns, etc.) or food cut into slices does not need to be cut up.

Ethanol with a proof strength of over 80^{•} and preferably with a proof strength of about 95^{•} is preferably used.

However, it is obvious that while an alcohol with a proof strength of under 80^{•} is not suitable for cooking, it does, in spite of that retain its flavour extraction ability and could in spite of everything be used to prepare concentrates intended to make up the final fuel.

For example, ten litres of 80^{•} ethanol are used to extract the flavours from ten kilos of extra-strong chilli peppers. This mixture known as an alcoholate is mixed with 200 litres of 96^{•} alcohol to yield 210 litres of 95.23^{•} alcohol.

The advantages of the method are, in particular, as follows:
the juices of the food are fully retained because the heat completely envelops the pieces,
cooking without added fat,
cooking without odour,
rapid cooking (1 to 5 min),
fuel-economic cooking (about 1 1 of 95^{•} ethanol for 4 kg of food),
use of denatured alcohol, that is to say alcohol unsuitable for direct consumption (because of the addition of the flavours) and on which the duty is far lower,
simplicity of the means used,
ability of the alcoholate to impart the scents and flavours after burning, making it possible to envisage a variety of varied scents and flavours,
possibility of using this method to seal meat, cut up or otherwise, without cooking it,
the great amount of heat given off has a bactericidal effect.

Finally, it is recalled that denatured ethanol is an ethyl alcohol rendered unfit for consumption according to the legislation in force and obtained by the fermentation of sugary plants. The invention therefore offers a novel commercial outlet for denatured ethanol in particular, but nonlimitingly, to ethanol obtained from sugar cane, beet, etc.

The invention therefore consists in using the LCV (calorific value) of the ethanol to cook food by direct contact between the food and the burning ethanol.

This combustion is therefore performed in the liquid medium (ethanol) and stops as soon as the said liquid has been completely exhausted by burning, avoiding any formation of toxic residues.

An apparatus for one exemplary implementation of the cooking method according to the invention is now described.

This nonlimiting example of implementation relates to the cooking of kebabs or of food packaged in a casing, for example sausages.

The cooking of kebabs is described hereinafter with reference to FIGS. 5 and 6.

The kebabs (1) are conventional kebabs formed of cubes of meat, vegetables, fish, offal, etc. threaded on to a stake or a skewer (2) and may have a size outside of the conventional standards (1 kilogram or even more).

Unlike conventional cooking on a grill where the kebabs are subjected to a method of cooking by radiation of heat, the cooking method using ethanol allows the food contained on the kebab skewer to be cooked by direct contact with the ignited ethanol.

To do this, the kebab is positioned inside a half-tube (3) made of stainless steel or some material able to satisfy both the temperature and hygiene requirements.

The half-tube (3) in which the kebab is positioned is closed off at each end by semicircular plates (4) made of the same material as the half-tube, so as to form a sealed trough.

Each end of the half-cylinder comprises a central cut-out (5) which will allow the kebab to be guided such that the kebab is correctly centred.

The half-cylinder has a diameter and a length which are determined by the size of the kebab to be cooked.

Development of future apparatuses using this cooking method already entails the half-cylinders being removable and of different sizes both in terms of their diameter and in terms of their length.

As far as the actual cooking is concerned, the kebab of food for cooking is positioned in a half-cylinder of a diameter and of a length which is suited to the kebab.

Suited is to be understood as meaning that the kebab must occupy a maximum amount of space in the half-cylinder while at the same time being able to rotate freely on itself without ever touching the half-cylinder as this could impede the rotation of the kebab.

Once the operator has made sure that the kebab is free to turn on itself, he fills the half-cylinder with a volume (6) of flavoured ethanol determined by the size of the kebab and by the desired degree of cooking, for example 2 to 3 cm³.

The operator then lights the ethanol either by hand or by an automatic means.

Once the ethanol has been lit, the operator turns the kebab either manually or by an automatic means, and for this reason, a motorized drive for the skewer (2) may be provided.

The rotating kebab will then absorb ethanol in the bottom part of the half-cylinder and will burn upon contact with the oxygen in the air when the upper part of the kebab comes out of immersion. When combustion of the ethanol is over, the kebab is cooked.

It should be noted that forthcoming developments in this type of equipment will lead to apparatuses allowing several kebabs of different sizes to be cooked at the same time by providing several half-cylinders on the same apparatus.

In addition, as with conventional cooking, it is possible in this way to cook sausages (7) by replacing the stake or skewer (2) with two mini-skewers with claws (8) (see FIG. 7).

Finally, it is certain that improvements can be made to the half-cylinder so that the ethanol can be supplied continuously or so as to be able to improve the shape of the half-cylinders by combining smaller half-cylinders intended to collect any fat resulting from cooking in ethanol.

In any event, it is preferable for the space between the kebab (or the sausage) and its container in the form of a closed half-tube to be small, for example to the order of 1 to 3 mm, so as to increase the depth of alcohol for a predetermined cooking volume and thus reduce the height of the flames.

1. Method for cooking food positioned in a receptacle, characterized in that:
a predetermined volume V of denatured ethanol with a proof strength of at least 80^{•} is poured on to the food,
the ethanol is ignited and left to burn completely.

2. Method according to claim 1, characterized in that the proof strength of the ethanol is preferably between 94^{•} and 96^{•}.

3. Method according to one of claims 1 to 2, characterized in that the ethanol is scented beforehand by macerating or infusing ingredients.

4. Method according to claim 3, characterized in that the ingredients are chosen from the group (aromatic herbs, fresh plants, spices, condiments, vegetables, flowers).

5. Method according to one of claims 1 to 4, characterized in that the food is cut up into pieces beforehand.

6. Method according to one of claims 1 to 5, characterized in that the pieces have a volume contained approximately in cubes with a side length of 1.5 to 2.5 cm.

7. Method according to one of claims 1 to 6, characterized in that the volume V is determined with respect to the mass of food to be cooked in the proportion 1 1 of 95^{•} ethanol to about 4 kg of food.

8. Apparatus for cooking food, characterized in that it is designed to implement the method according to one of claims 1 to 7 and characterized in that it is formed of at least a half-tube (3) closed off at each end by half-plates (4) in the shape of half-discs, each comprising a central cut-out (5) for guiding a skewer (2) or half-skewers (8) holding the food that is to be cooked.

9. Apparatus according to claim 9, characterized in that it comprises an automatic means for rotating the skewer or half-skewers.

10. Apparatus according to one of claims 8 to 9, characterized in that it comprises means intended to collect the fat.

11. Apparatus according to one of claims 8 to 10, characterized in that it comprises means for continuously supplying the cooking ethanol.
